(19) United States
(12) Patent Application Publication
(10) Pub. No.: US 2008/0004387 A1
(43) Pub. Date: Jan. 3, 2008

(54) Alkyl benzyl esters of polycarboxylic acids

(76) Inventors: Thomas Weiss, Monheim (DE); Eberhard Kuckert, Leverkusen (DE); Melanie Wiedemeier, Dormagen-Delhoven (DE)

Correspondence Address: LANXESS CORPORATION, 111 RIDC PARK WEST DRIVE, PITTSBURGH, PA, 15275-1112, US

(21) Appl. No.: 11/820,624

(22) Filed: Jun. 20, 2007

(30) Foreign Application Priority Data
Jun. 30, 2006 (DE) 10 2006 030 306.7
Jul. 14, 2006 (DE) 10 2006 033 097.8

(51) Int. Cl. C08K 5/10

(52) U.S. Cl. 524/306

(57) ABSTRACT

Ester mixtures composed of polyalkyl esters of aromatic or aliphatic polycarboxylic acids, of alkyl benzyl esters of aromatic or aliphatic polycarboxylic acids and of polybenzyl esters of aromatic or aliphatic polycarboxylic acids, and also a chemical process for preparation of some of these ester mixtures and to their use as plasticizers.

The invention relates to ester mixtures composed of polyalkyl esters of aromatic or aliphatic polycarboxylic acids, of alkyl benzyl esters of aromatic or aliphatic polycarboxylic acids and of polybenzyl esters of aromatic or aliphatic polycarboxylic acids, and also to a chemical process for preparation of some of these ester mixtures and to their use as plasticizers.

### BACKGROUND ON THE INVENTION

Plasticizers have been used for decades for the processing of plastics, such as polyvinyl chloride. Recently, the requirements placed upon plasticizers became more stringent in terms of performance and lack of toxicity with respect to humans and the environment. An important demand relates to a very low solubility temperature. The solubility temperature in the context of plasticizers is the temperature at which a polyvinyl chloride dispersion in a plasticizer becomes a homogeneous phase (L. Meier: “Weichmacher” [Plasticizers], in R. Gächter, H. Müller (Ed.): Taschenbuch der Kunststoffadditive, [Plastics additives handbook] 3rd Edition, pp. 361-362, Hanser Verlag, Munich 1990). Plasticizers with low solubility temperature permit rapid processing with energy saving.

According to the prior art, applications which demand a low solubility temperature mainly use alkyl benzyl esters of aromatic polycarboxylic acids, e.g. butyl benzyl phthalate, (L. Meier: “Weichmacher” [Plasticizers], in R. Gächter, H. Müller (Ed.): Taschenbuch der Kunststoffadditive, [Plastics additives handbook] 3rd Edition, p. 397, Hanser Verlag, Munich 1990). These can be prepared at low cost via reaction of aliphatic alcohols with aromatic polycarboxylic acids or with their cyclic anhydrides and with benzyl halides, e.g. benzyl chloride in the presence of a base. The preparation process can be carried out stepwise or can be a one-pot process (DE-A 1 468 373 for benzyl alkyl phthalates, DE-A-1 593 047 for benzyl alkyl trimellitates).

However, modern plasticizers are required to have not only a low solubility temperature but also low volatility. Volatility of plasticizers leads to undesired embrittlement of plasticized polyvinyl chloride, and also to pollution by what are known as volatile organic substances (VOCs), which are to be avoided in applications close to the consumer.

Butyl benzyl phthalate has a very low solubility temperature, but is volatile. GB 969,911 discloses alkyl benzyl phthalates having a relatively long alkyl chain, an example being benzyl octyl phthalate, and these are less volatile. A disadvantage with all of the alkyl benzyl phthalates, however, is the production of large amounts of corrosive salt during their preparation via benzylation using benzyl chloride. This requires aqueous work-up with production of wastewater, which incurs costs. Furthermore, the corrosive action of benzyl chloride, which eliminates HCl at high temperature, requires use of corrosion-resistant apparatus.

L. M. Bolotina, E. G. Maksimenko, G. V. Maksimova, Khimicheskaya Promyshlennost (Moscow) 1978, 54 (4), 257-259 (Chemical Abstracts 1978:423904) describes the preparation of butyl benzyl phthalate via esterification of a mixture composed of phthalic anhydride, n-butanol and benzyl alcohol.

The object of the present invention consisted in finding plasticizers with low solubility temperature and low volatility which can be prepared simply without formation of wastewater and without benzyl chloride.

### SUMMARY OF THE INVENTION

Surprisingly, it has now been found that ester mixtures composed of polyalkyl esters of aromatic or aliphatic polycarboxylic acids or of alkyl benzyl esters of aromatic or aliphatic polycarboxylic acids or of polybenzyl esters of aromatic or aliphatic polycarboxylic acids have unexpectedly low solubility temperatures together with low volatility. This invention therefore provides ester mixtures whose constitution is as follows:
a) from 2 to 98% by weight of one or more esters of the structure Z-(COOR²)ₘ₋ₙ(COOR¹)ₙ and
b) from 2 to 98% by weight of an ester of the structure Z-(COOR²)ₘ
   where the total of the percentages by weight composed of the components of the ester mixtures gives 100% and
   in which
R¹ is a straight-chain or branched C₁-C₂₀-alkyl radical,
R² is an optionally C₁-C₄-alkyl- or halogen-substituted benzyl radical,
Z is an m-valent saturated or unsaturated, straight-chain, branched, cyclic or polycyclic C₂-C₁₀ hydrocarbon radical,
m is a number from 2 to 4 and
n is a whole number from 1 to m.

The radical R¹ is preferably n-butyl, 2-ethylhexyl or isononyl.

The radical R² is preferably benzyl (═—CH₂—Ph).

The radical Z preferably derives structurally from phthalic, terephthalic, pyromellitic, trimellitic, maleic, fumaric, adipic, azelaic or sebacic acid.

In one particularly preferred embodiment of the invention, the ester of the structure Z-(COOR²)ₘ₋ₙ(COOR¹)ₙ where m=n=2 is diisononyl phthalate and for m=2 where n=1 it is isononyl benzyl phthalate and the ester of the structure Z-(COOR²)ₘ is dibenzyl phthalate.

In an alternative, particularly preferred embodiment of the invention, the ester of the structure Z-(COOR²)ₘ₋ₙ(COOR¹)ₙ, where m=n=3 is tributyl trimellitate and for m=3 where n=1 or 2 it is benzyl dibutyl trimellitate or, respectively, dibenzyl butyl trimellitate and the ester of the structure Z-(COOR²)ₘ is tribenzyl trimellitate.

### DETAILED DESCRIPTION OF THE INVENTION

The inventive ester mixtures can be prepared via mixing of components known per se in the stated ratio. If the inventive ester mixtures comprise more than two components, they can advantageously also be prepared via mixed esterification. The invention therefore also provides a process for preparation of ester mixtures comprising
a) from 2 to 98% by weight of one or more esters of the structure Z-(COOR²)ₘ₋ₙ(COOR¹)ₙ and
b) from 2 to 98% by weight of an ester of the structure Z-(COOR²)ₘ
   where the total of the percentages by weight composed of the components of the ester mixtures gives 100% and
   in which
R¹ is a straight-chain or branched C₁-C₂₀-alkyl radical,
R² is an optionally C₁-C₄-alkyl- or halogen-substituted benzyl radical,
Z is an m-valent saturated or unsaturated, straight-chain, branched, cyclic or polycyclic C₂-C₁₀ hydrocarbon radical,
m is a number from 2 to 4 and
n is a whole number from 1 to m,
   characterized in that, in one step of a process, at least one aromatic or aliphatic polycarboxylic acid or a derivative thereof, at least one benzyl alcohol and at least one aliphatic alcohol are reacted with one another at temperatures of from 50 to 300° C. and at pressures of from 2 mbar to 4 bar optionally in the presence of a catalyst and the water of reaction here is removed from the mixture via suitable measures.

A plurality of esters means in the present application from >1 to m, preferably from 2 to 4. The form in which these aromatic or aliphatic polycarboxylic acids can be introduced into the inventive process is that of the acid itself or of a derivative, e.g. an anhydride, ester, or acyl chloride. In one preferred embodiment of the invention, the polycarboxylic acids and/or their anhydrides are used.

The reaction can be completed via removal of the water of reaction. This can be achieved by way of example by means of entrainers, such as xylene or toluene, or else preferably via use of an alcohol which itself participates in the reaction. Water is particularly preferably removed in the range of temperatures from 50 to 250° C. and pressures in the range from 200 mbar to 4 bar.

The reaction partners used in the inventive process are (1) aromatic or aliphatic polycarboxylic acids or their anhydrides, (2) benzyl alcohols, (3) monohydroxy-aliphatic alcohols and optionally (4) catalysts. A detailed description of these reaction partners follows.

Anhydrides to be used according to the invention can be those either of the aliphatic or of the aromatic acids and may be saturated or unsaturated. Examples of suitable anhydrides are the anhydrides of phthalic, pyromellitic, trimellitic, maleic, succinic and glutaric acid. For the purposes of the inventive process, the anhydride can be added in the form of melt, in the form of solid, e.g. in the form of flakes, or in the form of solution to a reaction zone.

Examples of benzyl alcohols to be used according to the invention are benzyl alcohol, and also alkyl-substituted benzyl alcohols, e.g. methylbenzyl alcohol, ethylbenzyl alcohol, dimethylbenzyl alcohol, and the like, and the halo-substituted benzyl alcohols, e.g. chlorobenzyl alcohol, dichlorobenzyl alcohol, trichlorobenzyl alcohol, bromobenzyl alcohol, dibromobenzyl alcohol, and the like.

Alcohols to be used according to the invention are monohydric aliphatic alcohols, such as methyl alcohol, ethyl alcohol, propyl alcohol, isopropyl alcohol, butyl alcohols, such as n-butyl alcohol and sec-butyl alcohol, isobutyl alcohol, amyl alcohol, hexyl alcohols, such as n-hexyl alcohol, 1,4-dimethylbutyl alcohol, n-heptyl alcohol, octyl alcohols, such as isooctyl alcohols, n-octyl alcohol, 2-ethylhexanol, n-nonyl alcohol, isononyl alcohols, decyl alcohols, such as n-decyl alcohol, isodecyl alcohol, 2-propylheptanol, dodecyl alcohol, tridecyl alcohol, tetradecyl alcohol, penta-decyl alcohol, cetyl alcohol, octadecyl alcohol, and eicosyl alcohol; cycloaliphatic alcohols, such as cyclopropyl carbinol, cyclobutyl alcohol, cyclopentyl alcohol, methylcyclopentyl alcohol, di-methylcyclopentyl alcohol, ethylcyclopentyl alcohol, cyclohexyl alcohol, methylcyclohexyl alcohol, dimethylcyclohexyl alcohol and cyclooctyl alcohol; and unsaturated aliphatic alcohols, such as allyl alcohol, crotyl alcohol and the like. Furthermore, all of the various isomeric forms of these alcohols and mixtures of the same are suitable for use in the inventive process. The origin of the alcohol does not moreover affect the process, and it is therefore possible by way of example to use aliphatic alcohols which come from single- or two-stage oxo processes, from the hydration of olefins or from the catalytic dehydrogenation of coconut oil, these being in practice desirable because of their availability.

Catalysts to be used according to the invention, if appropriate, are in principle any of the esterification catalysts. Catalysts of the formula
MXₙ
where
M is selected from the group of titanium, zirconium, vanadium, aluminium, iron, tin,
X is selected from the group of CO₃²⁻, Cl, Br, I; OR, where R is selected from methyl, ethyl, n-propyl, isopropyl, n-butyl, isobutyl, tert-butyl; carboxylates in particular hexanoate, heptanoate, octanoate, 2-ethylhexanoate, stearate, palmitate, oxalate
n is oxidation number of the metal, preferably 2, 3 or 4,
   are particularly preferably used.

As an alternative, successful use can also be made of strong Brönsted acids, such as sulphuric acid, acidic sulphates, e.g. methyl sulphate, ethyl sulphate, propyl sulphate, butyl sulphate, hexyl sulphate, or else KHSO₄ or NaHSO₄, aromatic sulphonic acids, in particular para-toluenesulphoniic acid, benzenesulphonic acid.

The invention also encompasses the use of the ester mixtures as plasticizers for plastics, such as polyvinyl chloride, vinyl-chloride-based copolymers, polyvinylidene chloride, polyvinyl acetals, polyacrylates, polyamides, polyurethanes, polylactides, polylactic acids, cellulose and its derivatives, rubber polymers, such as acrylonitrile-butadiene rubber, hydrogenated acrylonitrile-butadiene rubber, chloroprene rubber, chlorinated polyethylene, chlorosulphonyl polyethylene, ethylene-propylene rubber, acrylate rubber and/or epichlorohydrin rubber. Polyvinyl chloride is preferred.

The polyvinyl chloride here is preferably prepared via homopolymerization from vinyl chloride by methods known to the person skilled in the art, e.g. suspension polymerization, emulsion polymerization or bulk polymerization. The inventive ester mixtures are preferably used in mixtures with from 20 to 99% of polyvinyl chloride, preferably 45 to 95% of polyvinyl chloride, particularly preferably from 50 to 90% of polyvinyl chloride. These mixtures are called plasticized polyvinyl chloride and can also comprise other suitable additives alongside the inventive ester mixtures and polyvinyl chloride. By way of example, stabilizers, lubricants, fillers, pigments, flame retardants, light stabilizers, blowing agents, polymeric processing aids, impact modifiers, optical brighteners, antistatic agents and/or biostabilizers may be present.

The plastics preferably also comprise additives, such as stabilizers, lubricants, fillers, pigments, flame retardants, light stabilizers, blowing agents, polymeric processing aids, impact modifiers, optical brighteners, antistatic agents and/or biostabilizers, or else a mixture thereof.

Some suitable additives are described in more detail below. The examples listed do not, however, represent any restriction of the inventive mixtures, but serve merely for illustration. All of the data relating to content are % by weight data.

Stabilizers neutralize the hydrochloric acid eliminated during and/or after processing of the polyvinyl chloride. Stabilizers that can be used are any of the conventional polyvinyl chloride stabilizers in solid or liquid form, for example conventional epoxy/zinc, Ca/Zn, Ba/Zn, Pb or Sn stabilizers, or else acid-binding phyllosilicates, such as hydrotalcite. The inventive ester mixtures can be used in mixtures whose content of stabilizers is from 0.05 to 7%, preferably from 0.1 to 5%, particularly preferably from 0.2 to 4% and in particular from 0.5 to 3%.

Lubricants are intended to act between the polyvinyl chloride particles and to counteract frictional forces during mixing, plastification and deformation. Lubricants that can be present in the inventive mixtures are any of the conventional lubricants for the processing of plastics. By way of example, it is possible to use hydrocarbons, such as oils, paraffins and PE waxes, fatty alcohols having from 6 to 20 carbon atoms, ketones, carboxylic acids, such as fatty acids and montanic acids, oxidized PE wax, metal carboxylates, carboxamides, and also carboxylic esters, for example with the alcohols ethanol, fatty alcohols, glycerol, ethanediol, pentaerythritol and long-chain carboxylic acids as acid component. The inventive ester mixtures can be used in mixtures whose content of lubricants is from 0.01 to 10%, preferably from 0.05 to 5%, particularly preferably from 0.1 to 3% and in particular from 0.2 to 2%.

Fillers primarily have a favourable effect on compressive strength, tensile strength and flexural strength, and also the hardness and heat resistance of plasticized polyvinyl chloride or polyvinyl bromide. For the purposes of the invention, the mixtures can also comprise fillers, such as carbon black and other inorganic fillers, such as natural calcium carbonates, e.g. chalk, limestone and marble, synthetic calcium carbonates, dolomite, silicates, silica, sand, diatomaceous earth, aluminium silicates, such as kaolin, mica and feldspar. Fillers preferably used are calcium carbonates, chalk, dolomite, kaolin, silicates, talc or carbon black. The inventive ester mixtures can be used in mixtures whose content of fillers is from 0.01 to 80%, preferably from 0.1 to 60%, particularly preferably from 0.5 to 50% and in particular from 1 to 40%.

The mixtures prepared with the inventive ester mixtures can also comprise pigments, in order to match the resultant product to various possible uses. For the purposes of the present invention, it is possible to use either inorganic pigments or else organic pigments. Examples of inorganic pigments that can be used are cadmium pigments, such as CdS, cobalt pigments, such as CoO/Al₂O₃, and chromium pigments, such as Cr₂O₃. Organic pigments that can be used are monoazo pigments, condensed azo pigments, azomethine pigments, anthraquinone pigments, quinacridones, phthalocyanine pigments, dioxazine pigments and aniline pigments. The inventive ester mixtures can be used in mixtures whose content of pigments is from 0.01 to 10%, preferably from 0.05 to 5%, particularly preferably from 0.1 to 3% and in particular from 0.5 to 2%.

In order to reduce flammability and smoke generation during combustion, the inventive mixtures can also comprise flame retardants. Examples of flame retardants that can be used are antimony trioxide, phosphate esters, chloroparaffins, aluminium hydroxide, boron compounds, molybdenum trioxide, ferrocene, calcium carbonate or magnesium carbonate. The inventive ester mixtures can be used in mixtures whose content of flame retardant is from 0.01 to 30%, preferably from 0.1 to 25%, particularly preferably from 0.2 to 20% and in particular from 0.5 to 15%.

The mixtures can also comprise light stabilizers in order to protect items produced from a mixture comprising the inventive ester mixtures from damage in the region of the surface via the effect of light. For the purposes of the present invention, hydroxybenzophenolnes or hydroxyphenylbenzotriazoles can be used, for example. The inventive ester mixtures can be used in mixtxures whose content of light stabilizers is from 0.01 to 7%, preferably from 0.1 to 5%, particularly preferably from 0.2 to 4% and in particular from 0.5 to 3%. All of the % data in this application are % by weight unless otherwise stated.

The plastics preferably also comprise further plasticizers, such as monoalkyl esters of benzoic acid, benzoic acid diesters of mono-, di-, tri- or polyalkylene glycols, dialkyl esters of aliphatic diacids, dialkyl esters of aromatic diacids, trialkyl esters of aromatic triacids, phenyl esters of alkanesulphonic acids, alkyl or aryl esters of phosphoric acid, polyesters composed of dicarboxylic acids, or else a mixture thereof.

Examples of further plasticizers are
the monoalkyl esters of benzoic acid, e.g. isononyl benzoate,
the benzoic diesters of mono-, di-, tri- or polyalkylene glycols, e.g. propylene glycol dibenzoate, diethylene glycol dibenzoate, dipropylene glycol dibenzoate, triethylenie glycol dibenzoate or polyethylene glycol dibenzoate and in particular mixtures thereof,
the dialkyl esters of aliphatic diacids, e.g. di(2-ethylhexyl) adipate, diisononyl adipate, di(2-ethylhexyl) sebacate, di(2-ethylhexyl) azelate, diisononyl cyclohexane-1,2-dicarboxylate,
the dialkyl esters of aromatic diacids, e.g. di(2-ethylhexyl) phthalate, diisononyl phthialate, diisodecyl phthalate, benzyl butyl phthalate, benzyl isooctyl phtlialate, benzyl isononyl phthalate,
the trialkyl esters of aromatic triacids, e.g. trioctyl trimellitate,
the phenyl esters of alkanesulphonic acids, e.g. the product Mesamoll® from LANXESS Deutschland GmbH,
the alkyl or aryl esters of phosphoric acid, e.g. tri(2-ethylhexyl) phosphate, diphenyl 2-ethylhexyl phosphate, diphenyl cresyl phosphate or tricresyl phosphate,
polyesters which can be prepared by way of example from dicarboxylic acids, such as adipic acid or phthalic acid and from diols such as 1,2-propanediol, 1,3-butanediol, 1,4-butanediol or 1,6-hexanediol.

For the purposes of the invention, the inventive ester mixtures can also be used in mixtures which comprise further plastics selected from the group consisting of homo- and copolymers based on ethylene, on propylene, on butadiene, on vinyl acetate, on glycidyl acrylate, on glycidyl metliacrylate, on acrylates and methacrylates having alcohol components of branched or unbranched C₁-C₁₀ alcohols, or styrene or acrylonitrile. Examples that may be mentioned are polyacrylates having identical or different alcohol radicals from the group of the C₄-C₈ alcohols, particularly of butanol, of hexanol, of octanol and of 2-ethylhexanol, polymethyl methacrylate, methyl methacrylate-butyl acrylate copolymers, methyl methacrylate-butyl methacrylate copolymers, ethylene-vinyl acetate copolymers, chlorinated polyethylene, nitrile rubber, acrylonitrile-butadiene-styrene copolymers, ethylene-propylene copolymers, ethylene-propylene-diene copolymers, styrene-acrylonitrile copolymers, acrylonitrile-butadiene rubber, styrene-butadiene elastomers and methyl methacrylate-styrene-butadiene copolymers.

The plastics mixtures prepared with the inventive ester mixtures are by way of example useful for production of pipelines, of cables, of wire sheathing, in the fitting-out of interiors, in the construction of vehicles and of furniture, in floor coverings, in medical items, in food-or-drink packaging, in gaskets, in foils, in composite foils, in foils for laminated safety glass, in particular for the vehicle sector and the architectural sector, in synthetic leather, in toys, in packaging containers, in adhesive-tape foils, in clothing, in coatings, and also in fibres for wovens.

The inventive ester mixtures have good processability due to their low solubility temperatures and have low volatility.

The plasticizers and the processes of this invention are illustrated via the examples below, which do not restrict the scope of the invention. [data in percentage by area].

Determination of Solubility Temperature

To determine solubility temperature, 48 g of the plasticizers to be tested were mixed with 2 g of Vinnol® H70 polyvinyl chloride, grain size <315 μm, and 2 drops of Irgastab® 17 M in a glass beaker. The suspension was heated at from 2 to 3° C. per minute, with stirring, until a temperature has been reached at which for 3 minutes in succession there is no further observable rise in the value indicated by a photocell positioned behind the glass beaker and the polyvinyl chloride has dissolved.

Determination of Volatility

The measure used for volatility comprised the amount of condensable constituents determined as follows. 10 g of the plasticizer here are placed in a thermostatically controlled cylindrical vessel (fogging test apparatus N8-FPG). The condensation surfaces used comprise a cooled aluminium foil whose weight was determined in advance. The sealed cylinder is then heated to 100° C. for 16 h. The aluminium foil is then removed. After 4 h of storage in a desiccator, the increase in weight is determined via difference weighing. Two determinations of volatility are carried out.

It will be understood that the specification and examples are illustrative but not limitative of the present invention and that other embodiments within the spirit and scope of the invention will suggest themselves to those skilled in the art.

### EXAMPLES 1 BIS 10

### Preparation of Ester Mixtures

Benzyl alcohol and isononanol (benzyl alcohol/isononanol ratio see Table 1; 2.05 total molar equivalents of alcohol, based on phthalic anhydride) were used as initial charge in a nitrogen-gas-inertized 2 l three-necked round-bottomed flask with reflux condenser, internal thermometer and stirrer, and molten phthalic anhydride was then added dropwise, the reaction temperature being 95° C. The mixture was held at this temperature for a further 16 h. After cooling, xylene (15% by weight, based on the entire mixture) was added and a water separator was incorporated. The reactor was heated to 100° C. and once the temperature had been reached titanium tetra-n-butoxide (0.25% by weight, based on the entire mixture) was added. The course of the reaction is followed by means of titration [acid number (AN: mg KOH/g of substance); xylene dilution correction] and via measurement of the amount of water separated. The reaction temperature was increased from 140° C. to 180° C. over a period of from 15 to 20 h.

Once an AN (=acid number) of <1 had been reached, the experiment was ended and the product was treated with steam at 100° C. The steam distillation was ended once the volume condensed was twice that of the organic content. All of the volatile constituents were then removed at 140° C. and a pressure of 4 mbar and the residue was filtered after admixture of a mixture composed of MgO/activated charcoal. The products were analysed by means of HPLC to determine their constitution and were tested for performance as plasticizers in polyvinyl chloride.

TABLE 1

| | Example | | | | | | | | | |
|---|---|---|---|---|---|---|---|---|---|---|
| | 1 | 2 | 3 | 4 | 5 | 6 | 7 | 8 | 9 | 10 |
| Nonanol/benzyl alcohol | 0.98 | 0.51 | 1.00 | 1.03 | 1.00 | 1.00 | 1.00 | 1.22 | 1.62 | 1.00 |
| [mol/mol] | | | | | | | | | | |
| Constitution [%] | | | | | | | | | | |
| Dibenzyl phthalate | 26.00 | 37.76 | 30.44 | 30.57 | 30.68 | 28.04 | 30.06 | 23.86 | 17.16 | 28.3 |
| Isononyl benzyl phthalate | 48.82 | 45.87 | 49.87 | 49.64 | 50.96 | 52.26 | 51.47 | 50.08 | 48.13 | 49.2 |
| Diisononyl phthalate | 25.18 | 16.37 | 19.69 | 19.79 | 18.36 | 19.71 | 18.47 | 26.06 | 34.72 | 22.5 |

### EXAMPLE 11

### Preparation of an Ester Mixture

Benzyl alcohol and butanol (benzyl alcohol:n-butanol ratio=1:1 mol/mol; 3.9 total molar equivalents of alcohol, based on trimellitic anhydride) were used as initial charge in a nitrogen-gas-inertized 2 l three-necked round-bottomed flask with reflux condenser, internal thermometer and stirrer, and trimellitic anhydride was then added in portions, the reaction temperature being 95° C. The solution was then held at 125° C. for 1 h. After cooling, xylene (15% by weight, based on the entire mixture) was added and a water separator was incorporated. The reactor was heated to 100° C. and once the temperature had been reached titanium tetra-n-butoxide (0.28 mol %, based on trimellitic anhydride) was added. The course of the reaction is followed by means of titration [acid number (AN: mg KOH/g of substance); xylene dilution correction] and via measurement of the amount of water/butanol separated. The reaction temperature was increased to 165° C. within 23 h.

Once an AN of 2.5 had been reached, the experiment was ended and the product was treated with steam at 100° C. The steam distillation was ended once the volume condensed was twice that of the organic content. All of the volatile constituents were then removed at 140° C. and a pressure of 20 mbar and the residue was filtered after admixture of a mixture composed of Na₂CO₃/activated charcoal. The products were analysed by means of GCMS to determine their constitution and were tested for performance as plasticizers in polyvinyl chloride.

TABLE 2

| | Example |
|---|---|
| | 11 |
| Butanol/benzyl alcohol [mol/mol] | 1 |
| Yield [%] | 89.5 |
| Constitution % | |
| Tributyl trimellitate | 7.7 |
| Dibutyl benzyl trimellitate | 30.6 |
| Monobutyl dibenzyl trimellitate | 39.2 |
| Tribenzyl trimellitate | 11.5 |

### EXAMPLES 12 AND 13

### Preparation of an Ester Mixture

Benzyl alcohol and isononanol (benzyl alcohol:isononanol ratio see Table 3; 3.05 total molar equivalents of alcohol, based on trimellitic anhydride) were used as initial charge in a nitrogen-gas-inertized 2 l three-necked round-bottomed flask with reflux condenser, internal thermometer and stirrer, and trimellitic anhydride was then added in portions (1.0 molar equivalent), the reaction temperature being 95° C. The solution was then held at 125° C. for 2 h. After cooling, xylene (15% by weight, based on the entire mixture) was added and a water separator was incorporated. The reactor was heated to 100° C. and once the temperature had been reached titanium tetra-n-butoxide (0.28 mol %, based on trimellitic anhydride) was added. The course of the reaction is followed by means of titration [acid number (AN:mg KOH/g of substance); xylene dilution correction] and via measurement of the amount of water separated. The reaction temperature was increased from 120° C. to 170° C. within 3 h.

Once an AN of less than 2 had been reached, the experiment was ended and the product was treated with steam at 100° C. The steam distillation was ended once the volume condensed was twice that of the organic content. All of the volatile constituents were then removed at 140° C. and a pressure of 10 mbar and the residue was filtered after admixture of a mixture composed of MgO/activated charcoal. The products were analysed by means of GCMS to determine their constitution and were tested for performance as plasticizers in polyvinyl chloride.

TABLE 3

Example

| | 12 | 13 |
|---|---|---|
| Nonanol/benzyl alcohol [mol/mol] | 0.5 | 2 |
| Yield [%]: | 90 | 91 |
| Constitution [%] | | |
| Triisononylyl trimellitate | 2.5 | 20.3 |
| Diisononyl benzyl trimellitate | 26.2 | 51.0 |
| Monoisononyl dibenzyl trimellitate | 44.0 | 24.1 |
| Tribenzyl trimellitate | 27.2 | 4.5 |

### EXAMPLES 14 TO 17

The ester mixtures of Examples 14 to 17 were prepared using the preparation specifications stated for Examples 12 and 13 and using the starting materials and molar ratios stated in Table 4.

TABLE 4

| | Example | | | |
|---|---|---|---|---|
| | 14 | 15 | 16 | 17 |
| Alcohol R¹—OH | 2-ethylhexanol | isononanol | 2-ethylhexanol | isodecanol |
| Benzyl alcohol R²—OH | Ph-CH₂—OH | Ph-CH₂—OH | Ph-CH₂—OH | Ph-CH₂—OH |
| R¹—OH/R²—OH mol/mol | 1.0 | 1.0 | 1.0 | 1.0 |
| Acid Z(COOH)ₘ | pyromellitic acid | adipic acid | azelaic acid | sebacic acid |
| m | 4 | 2 | 2 | 2 |
| Total alcohol/acid mol/mol | 4.05 | 2.1 | 2.05 | 2.1 |
| Components of ester mixture | | | | |
| Z-(COOR²)ₘ | tetrabenzyl pyromellitate | dibenzyl adipate | dibenzyl azelate | dibenzyl sebacate |
| Z-(COOR²)ₘ₋ₙ(COOR¹)ₙ, where | tribenzyl 2-ethylhexyl | benzyl isononyl | benzyl 2-ethylhexyl | benzyl isodecyl |
| n = 1 | pyromellitate | adipate | azelate | sebacate |
| Z-(COOR²)ₘ₋ₙ(COOR¹)ₙ, where | dibenzyl di-2-ethylhexyl | diisononyl adipate | di-2-ethylhexyl azelate | diisodecyl sebacate |
| n = 2 | pyromellitate | | | |
| Z-(COOR²)ₘ₋ₙ(COOR¹)ₙ, where | benzyl tri-2-ethylhexyl | — | — | — |
| n = 3 | pyromellitate | | | |
| Z-(COOR²)ₘ₋ₙ(COOR¹)ₙ, where | tetra-2-ethylhexyl | — | — | — |
| n = 4 | pyromellitate | | | |

### Inherent Properties of the Ester Mixtures from Examples 10 to 13

TABLE 5

| | Solubility | | | |
|---|---|---|---|---|
| | temperature | Viscosity | Pour point | Condensate |
| | (° C.) | (mPas) | (° C.) | (mg) |
| Example | | | | |
| 10 | 123 | 78 | −32 | 31 |
| 11 | 120 | solid | solid | 1.1 |
| 12 | 142 | 381 | −26 | 1.1 |
| 13 | 142 | 749 | 1 | 0.4 |
| Non-inventive: | | | | |
| Dibenzyl phthalate | 145 | 221 | −12 | >30 reflux |
| Santicizer ® 261 A | 119 | 85 | −35 | 1.40 |
| Unimoll ® BB | 110 | 62 | −40 | 36 |
| Vestinol ® 9 | 132 | 82 | −54 | 1.46 |
| Uraplast ® 525 | 160 | 114 | −43 | 0.13 |

Santicizer ® 261 A: benzyl isononyl phthalate;
Unimoll ® BB: benzyl butyl phthalate;
Vestinol ® 9: diisononyl phthalate;
Uraplast ® 525: C₈-/C₁₀-trialkyl trimellitate of linear C₈/C₁₀ alcohols.

From the examples, it is easy to discern that the inventive process permits preparation of the inventive plasticizers in high yields while avoiding benzyl chloride and salt-loaded wastewater. The solubility temperatures of the inventive plasticizers are lower than the solubility temperatures of the pure polyalkyl esters or polybenzyl esters which they comprise. Their volatility is of the order of magnitude found for comparable plasticizers used commercially.

1. An ester mixture comprising
a) from 2 to 98% by weight of one or more esters of the structure Z-(COOR²)ₘ₋ₙ(COOR¹)ₙ and
b) from 2 to 98% by weight of an ester of the structure Z-(COOR²)ₘ
where the total of the percentages by weight composed of the components of the ester mixtures gives 100% and wherein
R¹ is a straight-chain or branched C₁-C₂₀-alkyl radical,
R² is an optionally C₁-C₄-alkyl- or halogen-substituted benzyl radical,
Z is an m-valent saturated or unsaturated, straight-chain, branched, cyclic or polycyclic C₂-C₁₀ hydrocarbon radical,
m is a number from 2 to 4 and
n is a whole number from 1 to m.

2. An ester mixture according to claim 1, wherein R² is benzyl.

3. An ester mixture according to claim 1 or 2, wherein R¹ is n-butyl, 2-ethylhexyl or isononyl.

4. An ester mixture according to claim 1, wherein the ester of the structure Z-(COOR²)ₘ₋ₙ(COOR¹)ₙ, where m=n=2 is diisononyl phthalate and for m=2 where n=1 it is isononyl benzyl phthalate and the ester of the structure Z-(COOR²)ₘ is dibenzyl phthalate.

5. An ester mixture according to claim 1, wherein the ester of the structure Z-(COOR²)ₘ₋ₙ(COOR¹)ₙ, where m=n=3 is tributyl trimellitate and for m=3 where n=1 or 2 it is benzyl dibutyl trimellitate or, respectively, dibenzyl butyl trimellitate and the ester of the structure Z-(COOR²)ₘ is tribenzyl trimellitate.

6. A one step process for the preparation of ester mixtures comprising
a) from 2 to 98% by weight of one or more esters of the structure Z-(COOR²)ₘ₋ₙ(COOR¹)ₙ and
b) from 2 to 98% by weight of an ester of the structure Z-(COOR²)ₘ
where the total of the % by weight composed of the components of the ester mixtures gives 100% and
R¹ is a straight-chain or branched C₁-C₂₀-alkyl radical,
R² is an optionally C₁-C₄-alkyl- or halogen-substituted benzyl radical,
Z is an m-valent saturated or unsaturated, straight-chain, branched, cyclic or polycyclic C₂-C₁₀ hydrocarbon radical,
m is a number from 2 to 4 and
n is a whole number from 1 to m,
wherein at least one aromatic or aliphatic polycarboxylic acid or a derivative thereof, at least one benzyl alcohol and at least one aliphatic alcohol are reacted with one another at temperatures of from 50 to 300° C. and at pressures of from 2 mbar to 4 bar optionally in the presence of a catalyst and the water of reaction here is removed from the mixture via suitable measures.

7. A process according to claim 6, wherein polycarboxylic acids or their derivatives, selected from the group consisting of phthalic acid, terephthalic acid, pyromellitic acid, trimellitic acid, sebacic acid, azelaic acid, adipic acid, maleic acid and fumaric acid are used.

8. A process according to claim 6 or 7, wherein a substituted or unsubstituted benzyl alcohol R²—OH is used in a mixture with one or more aliphatic alcohols, R¹—OH, in which R¹ has been selected from the group consisting of branched and unbranched alkyl, cycloalkyl and oxalkylene radicals.

9. A method of using ester mixtures according to claim 1 as plasticizers for plastics, such as polyvinyl chloride, vinyl-chloride-based copolymers, polyvinylidene chloride, polyvinyl acetals, polyacrylates, polyamides, polyurethanes, polylactides, polylactic acids, cellulose and its derivatives, rubber polymers, such as acrylonitrile-butadiene rubber, hydrogenated acrylonitrile-butadiene rubber, chloroprene rubber, chlorinated polyethylene, chlorosulphonyl polyethylene, ethylene-propylene rubber, acrylate rubber and/or epichlorohydrin rubber, in particular polyvinyl chloride.

10. A method of using ester mixtures according to claim 9, wherein the plastics also comprise additives, such as stabilizers, lubricants, fillers, pigments, flame retardants, light stabilizers, blowing agents, polymeric processing aids, impact modifiers, optical brighteners, antistatic agents and/or biostabilizers, or else a mixture thereof.

11. A method of using ester mixtures according to claim 10, wherein the plastics also comprise further plasticizers, such as monoalkyl esters of benzoic acid, benzoic acid diesters of mono-, di-, tri- or polyalkylene glycols, dialkyl esters of aliphatic diacids, dialkyl esters of aromatic diacids, trialkyl esters of aromatic triacids, phenyl esters of alkanesulphonic acids, alkyl or aryl esters of phosphoric acid, polyesters composed of dicarboxylic acids, or else a mixture thereof.
